(19) United States
(12) Patent Application Publication
(10) Pub. No.: US 2015/0101497 A1
(43) Pub. Date: Apr. 16, 2015

(54) PRESS FOR FRUITS AND VEGETABLES AND THE RELATING PRESSING METHOD

(71) Applicant: TMCI PADOVAN S.P.A., Vittorio Veneto (IT)

(72) Inventor: Osman Erdal SAGMANLI, Istanbul (TR)

(21) Appl. No.: 14/502,575

(22) Filed: Sep. 30, 2014

(30) Foreign Application Priority Data
Oct. 16, 2013 (IT) PN2013A000062

(51) Int. Cl. B30B 9/22; B30B 15/30

(52) U.S. Cl. CPC B30B 9/225; B30B 15/30
USPC 100/37; 100/107; 100/105

(57) ABSTRACT

The present invention relates to a press for fruit and vegetable products including at least one column that includes a feed element and several pressing stages. Each stage of pressing includes an essentially cylindrical outer shell which is internally associated with a pressure-deformable impermeable membrane which lines a respective pressing chamber in each stage. At least one perforated collector tube is positioned along the column inside each pressing chamber and coaxially to each outer shell.

### FIELD OF THE INVENTION

The present invention relates to a press for fruit and the like, such as grapes, apples, tomatoes, and the related method of pressing in order to extract the juice by simultaneously separating the solid phase from the liquid phase.

### DESCRIPTION OF THE PRIOR ART

The procedure of pressing the fruit is to extract the juicy part contained in the pulp by simultaneously separating it from the solid part, to derive, as a product of pressing, a juice that may be subject to a subsequent filtering process to obtain a liquid final product from which the solid or fibrous residues are completely eliminated.

With particular reference to the pressing of grapes, the procedure provides for crushing the grapes to obtain the must, i.e. the juicy part, and the separation of the latter from the solid part, composed of the pomace and possibly the stalks.

The prior art provides several types of presses for fruit, such as mechanical-type presses generally comprising an auger inside a perforated cylinder which mechanically propels the mass of fruit towards one end of the cylinder, pressing it with increasing pressure.

One drawback of mechanical pressing, particularly observed when it is used to extract the must from grapes, lies in the fact that the pulp is subjected to undesirable mechanical stresses, and it is difficult to control the contact with the moving mechanical parts. Consequently one cannot be sure that the pressing is soft enough to ensure the final product's quality. Mechanical-type presses are therefore not very suitable when it is necessary to obtain a controlled and quality product such as high quality must.

A pressing process able to overcome the drawbacks described above can be achieved with another type of press of a known type, consisting of membrane presses essentially formed of a cylinder with a perforated outer shell and containing an inner membrane that is pressure-deformable. After the product to be processed has been fed inside the membrane, a pressure is exerted that compresses the membrane and, consequently, the product contained inside of it; thus the liquid part of the product filters through the membrane gathering in the shell of the cylinder from which, through the perforations, it percolates outward to a collecting container, while the solid part remains in the membrane and is then discharged into a different collecting container.

This type of press, particularly suitable for grape pressing, ensures the required gentleness in extraction, as there are no moving mechanical parts present.

A drawback occurring both in the first mechanical-type press and in the second membrane type resides in the difficulty of thoroughly cleaning the machine at the end of the process.

In fact, with reference to membrane presses, which are better suited to food use due to the increased possibility of controlling the pressure applied, the peripheral drainage of the liquid phase leaves a deposit of organic residues of processed product on the outer shell that are particularly difficult to remove. Over time, these residues ferment and, if not carefully removed, cause contamination of the products obtained in subsequent pressing cycles with the quality of the final product lowered considerably.

### SUMMARY OF THE INVENTION

The object of the present invention is to provide a press for fruit and vegetable products, as well as a related method of pressing, able to overcome the drawbacks of the known art.

Within the scope of what is described above, one aim is to provide a press for fruit and vegetable products capable of ensuring a final product of high quality.

Another aim of the present invention is to provide a press that allows the machine and all of its parts to be thoroughly cleaned at the end of the work cycle.

A further aim is to provide a press that ensures a high level of hygiene during the products' processing, which is essential for the processing of food products such as fruit and the like and for related derivatives, such as juices, wines, and other products obtainable by pressing fruit and the like.

Another aim is to reduce the space occupied by the press.

Another aim is to provide a press for fruit and vegetable products that achieves the task and the aims indicated above at competitive costs and that is achievable with conventional and known machinery, systems, and equipment.

The above task and aims, and others which will become apparent hereinafter, are achieved by a press for fruit and vegetable products as defined in claim 1 and by a pressing method as defined in claim 10.

### BRIEF DESCRIPTION OF THE DRAWINGS

Further features and advantages achievable in a press for fruit and vegetable products and a related method of pressing according to the present invention will become more apparent from the following description of a particular, but not exclusive embodiment illustrated purely by way of non-limiting example with reference the following figures:

FIG. 1 shows a diagram of a system for pressing fruit or the like which comprises a press according to the present invention;

FIGS. 2 and 3 show, according to the front and rear perspective views, respectively, a press for fruit and the like according to the present invention;

FIG. 4 is a front view of the press cut-away along the plane IV-IV;

FIGS. 5 and 6 illustrate, according to a sectional view, a component of the press featured in the previous figures in a first and a second phase of the working cycle;

FIG. 7 is a detail of the press according to a view in cross-section;

FIGS. 8 and 9, according to the front and rear perspective views, respectively, show a second embodiment for a press for fruit and the like according to the present invention.

### DETAILED DESCRIPTION OF THE INVENTION

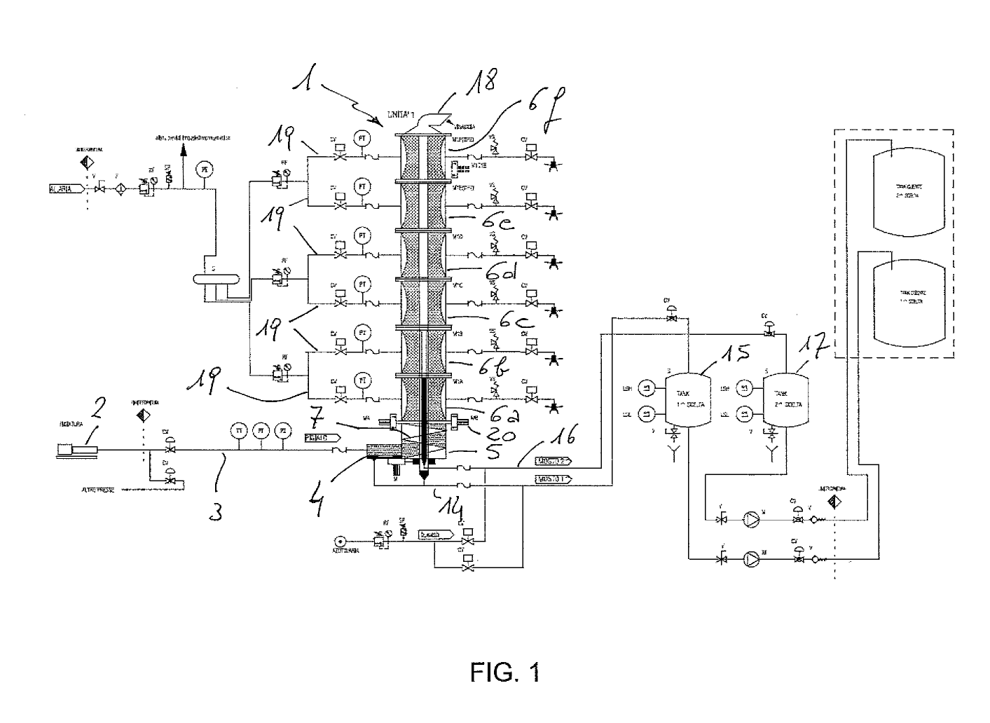

With reference to the above figures, FIG. 1 represents a diagram of the pressing system, which includes at least one press 1 for fruit and vegetable products according to the present invention.

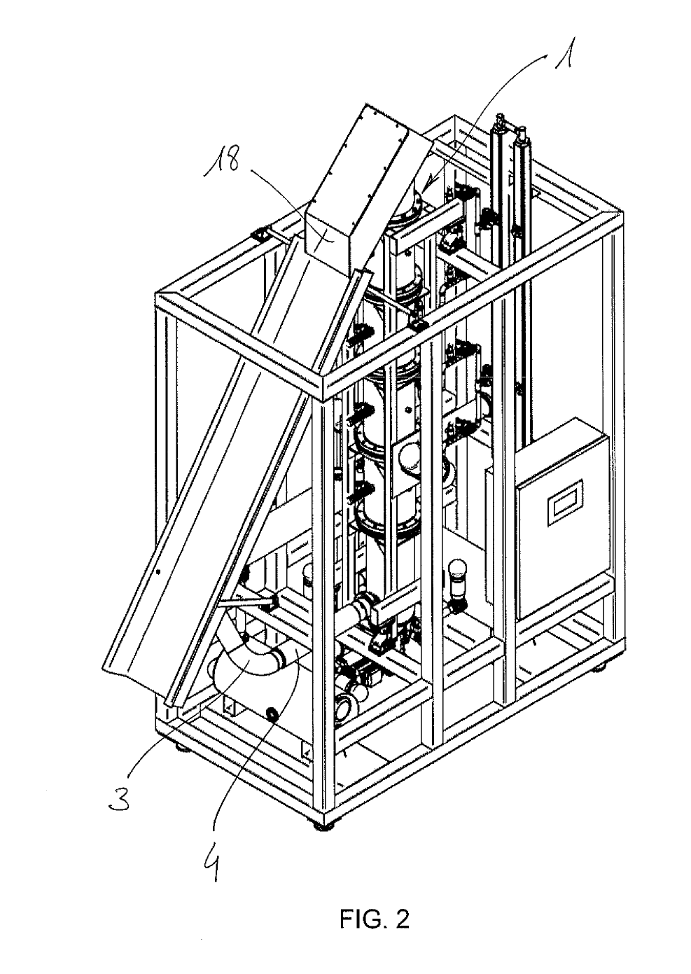

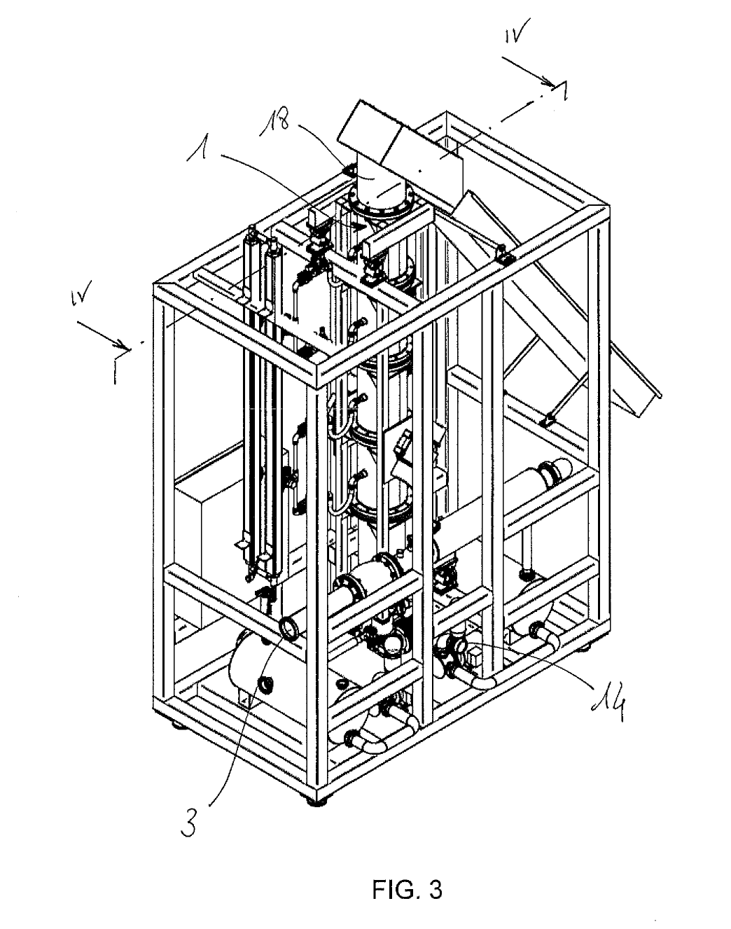

The product to be processed, for example whole or destemmed grapes or those destemmed and crushed in suitable destemming and/or crushing equipment 2 provided in the pressing system, is introduced, possibly through a special conduit 3 leading from the destemming and/or crushing equipment 2 to the inlet 4 of the press, represented in FIGS. 1 and 2, which comprises at least one column 1 positioned vertically and formed of a feed element 5 and multiple pressing stages, indicated by reference numbers 6a, 6b, 6c, 6d . . . but which in the following will also be indicated, in the interest of brevity, also with the reference number 6.

From the inlet 4, the product is then introduced into the feed element 5 which comprises the means of loading 7, such as an auger, which transfers the product from the inlet 4 toward the first pressing stage 6a and, in sequence, toward the subsequent stages 6b, 6c, etc.

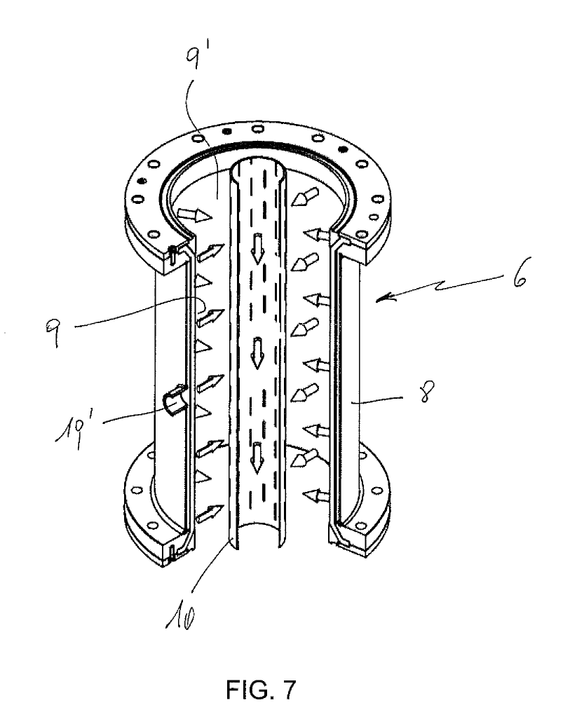

Each pressing stage 6a, 6b, 6c, 6d . . . comprises an essentially cylindrical outer shell 8 which is associated with an inner pressure deformable impermeable membrane 9 which lines a pressing chamber 9′ in its interior. With reference to FIG. 7, in which is shown by way of example a cross section of a single stage, there is at least one perforated collector tube inside the pressing chamber 9′ lined with the membrane 9 and coaxial to the outer shell 8, shown in FIG. 7 with the reference number 10. Between the outer shell 8 and the membrane 9, connected to the outer shell 8 at the upper and lower edges, a gap is provided to allow the passage, through an aperture 19′ connected to a pneumatic circuit of a pressurized fluid, preferably air, able to deform the membrane so as to move it away from the inner walls of the shell 8 and to press it radially towards the center of the stage 6 where the collector tube 10 is found.

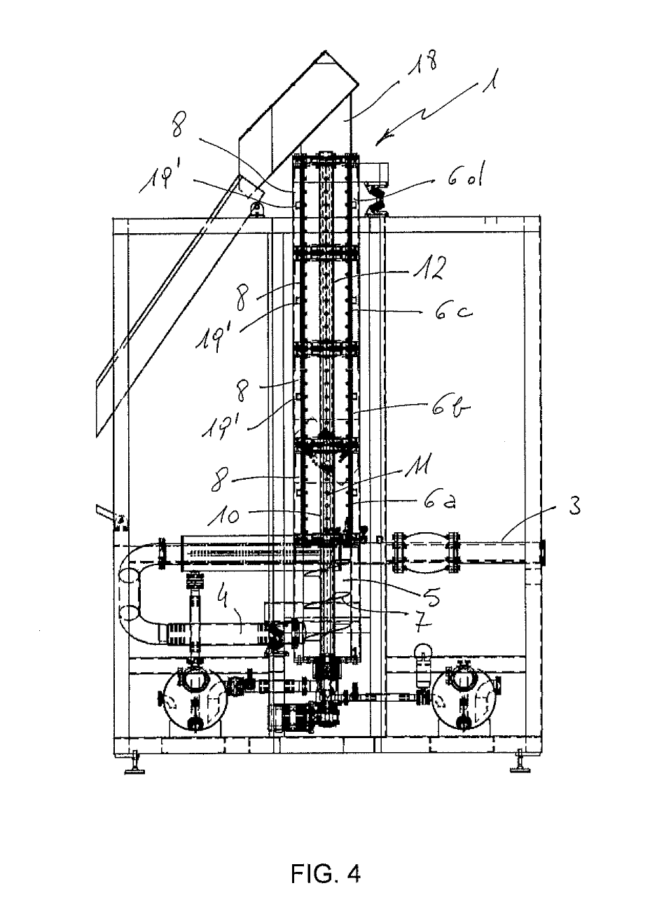

According to a preferred embodiment, illustrated in FIGS. 4 to 6, the press is provided with one or two collector tubes, depending on the distance of the single stage 6 by the feed element 5, arranged internally and coaxially to the outer shell 8.

The stages 6 adjacent to the feed element 5 that receive the unpressed fruit or fruit having undergone a first degree of pressing, defined as “primary stages” and indicated with 6a and 6b, are provided with a first collector tube 10, perforated and larger in diameter with respect to a second collector tube 11, which is not perforated and positioned inside and coaxially to the first collector tube 10. In the subsequent stages 6c, 6d, 6e, 6f, further from the feed element 5 and defined as “secondary stages”, only a third perforated collector tube 12 is provided.

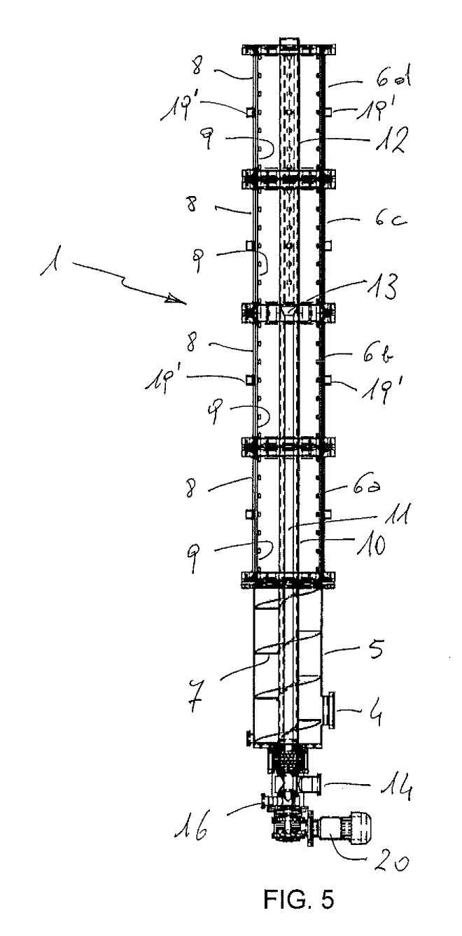

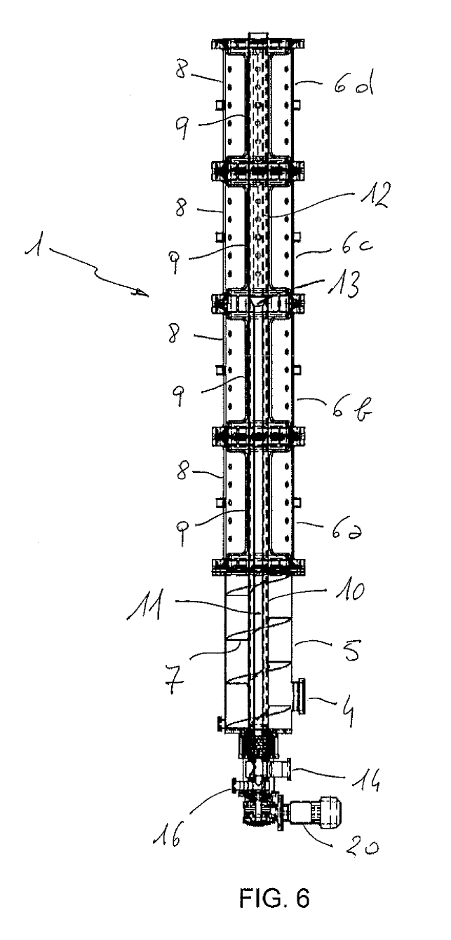

In the connection zone between the last primary stage of the first and second collector tube 10, 11 positioned coaxially, exemplified in FIGS. 5 and 6 with the reference number 6b, and the adjacent secondary stage 6c provided with only the third perforated collector tube 12, a joint 13 is provided which connects the third collector tube 12 to the second collector tube 11.

The first collector tube 10 communicates with a first outlet conduit 14 which transfers a first amount of liquid phase derived from the pressing of the product to a first collecting tank 15, while the second collector tube 11 communicates with a second outlet conduit 16 which transfers a second amount in liquid phase to a second collecting tank 17, distinct and separate from the first tank 15.

The solid phase of the product is instead pushed toward the top of the column 1 by the pressure of the incoming product in the first stage 6a and pushed upward by the auger 7, to a discharge outlet 18 located on the top of the column 1, from which it is ejected.

The pressure to deform the membrane 9 in each of the stages 6 is provided by one or more pneumatic compressors connected to their respective pneumatic circuits 19, preferably controlled by means such as a PLC, each connected to a stage 6 of the column 1 through the respective opening 19′.

The air pressure in the circuits 19, preferably controlled by the PLC, increases progressively from the stage 6a adjacent to the feed element 5 up to the stage 6f next to the discharge outlet 18. In FIG. 1, for example, the incoming air in the first two stages 6a and 6b has a pressure value P1, ranging from approximately 0.05 bar to 0.5 bar, lower than the pressure value P2, ranging from approximately 0.5 bar to 1.1 bar, which is less than the air input in the third and fourth stage 6c, 6d, in turn less than the pressure value P3 ranging from approximately 1.1 bar to 2 bar of the air entering in the fifth and sixth stage 6e, 6f.

The operation of the press according to the present invention is as follows with reference, by way of example, to the pressing of grapes: the latter, after being introduced via the inlet 4, in the feed element 5 in the form of whole grapes or grapes that have been destemmed and crushed using appropriate destemming and/or crushing equipment 2, are pushed by the auger 7 towards the first stage of pressing 6a in the chamber 9′ formed by the walls of the impermeable membrane 9. Subsequently feeding in additional grapes to be processed, pushed by the auger 7, determines the progressive upward transfer of the product and the extraction at the different stages of pressing 6 with progressively increasing pressures.

At the first two stages 6a, 6b the respective membranes 9, deforming due to the thrust exerted by the relatively low pressure P1 which causes them to move away from the shell 8, extract the first pressing of the grapes by compressing them against the first perforated collector tube 10. The first liquid phase separated from the rest of the product to be processed, and therefore that of higher quality, flows through the perforations along the first collector tube 10, out to the non-perforated second tube 11, to be collected, via the first outlet conduit 14, in the first tank 15. In the case of grapes, the product of this first pressing, achieved at low pressure, is the 1st quality must.

The product which has undergone the first pressing is then pushed upwards by the further incoming product, and then undergoes, due to the deformation of the respective membranes 9, a second pressing at the intermediate pressure P2 in the subsequent stages 6c, 6d and a third pressing, still more forceful, at the maximum pressure P3.

The compression of the membranes 9 in the respective stages 6c, 6d, 6e, 6f subjected to pressures P2 and P3 therefore permits the remaining liquid phase to be extracted, in this case the 2nd choice must, from the product and separates it from the solid phase consisting of skins and possibly stems as the must flows through the perforations of the third collector tube 12 and is conveyed, through the joint 13, into the non-perforated second tube 11 to be collected, through the second outlet conduit 16, in the second collection tank 17. The liquid produced from the second and third pressing is the 2nd choice must.

FIG. 5 schematically represents the column 1 during the feeding phase, in which the membranes 9 adhere to the inner walls of the respective shells 8, while FIG. 6 shows the column 1 in the pressing step during which the membranes 9, subjected to compression, deform by moving away from the respective shells 8 towards the perforated collector tubes 10 and 12.

It is shown how, due to the separation of the circuits between the 1st choice must and 2nd choice must and in particular due to the presence of the second non-perforated collector tube 11, which avoids any contamination between the two liquids within the column 1, the press according to the present invention ensures throughout the pressing cycle an optimal separation between the liquid phase achieved by the first pressing, the better quality 1st choice must, and the liquid phase achieved by the second and third pressing, the lower quality 2nd choice must. In this way, contamination and pollution between the two liquids, which would entail a reduction in the quality of the final product, is avoided.

Throughout the cycle, the solid mass is pushed towards the top of the column 1 by the product entering via the feed element 5 until it is ejected, now exhausted after the final phase of pressing, from the discharge outlet 18. The remaining solid product, consisting essentially of pomace, is collected in a suitable vessel separate from the must collecting tanks 15 and 17.

At the end of each pressing cycle, column 1 must be cleaned to remove the organic residues left by the processed product in order to avoid fermentation, which would contaminate subsequent products to be processed.

The press according to the present invention allows for an extremely easy and precise cleaning of the column 1. In fact, the impermeability of the membranes 9 keeps the inner walls of the shell 8 clean and uncontaminated by organic residues. It is therefore sufficient to spray with water, or other cleaning substances, from the top of the column 1 within the chambers lined with the inner surfaces of the membranes 9 and inside of the collector tubes 10, 11 and 12 to remove any organic residues left at the end of the pressing cycle.

Preferably, the base of the column 1 can be provided with some vibrating means 20, actuated by one or more electric motors, so as to shake the column 1 and facilitate a more uniform distribution of the product to be processed to achieve better and more complete pressing.

From the above it is therefore evident how the present invention achieves the purposes and advantages initially aimed for: it is in fact, devised as a press for fruit and vegetable products, and a related pressing process, which is able to overcome the drawbacks of the known art.

In particular, it is shown how the press according to the present invention is able to ensure a high quality final product, both due to the total separation of the circuits between the liquid produced from the first pressing and that produced from the subsequent pressing, which prevents contamination between the 1st choice product and that of the 2nd choice, and the high degree of hygiene of the process, due to the ease and simplicity of cleaning, which permits complete and precise removal of all organic residue remaining at the end of the pressing cycle.

Furthermore, the vertical arrangement of the column 1 allows the space occupied by the press to be reduced considerably, in contrast to similar known systems generally positioned horizontally. It also permits gravity cleaning with better and more effective results, as explained above.

Naturally, the present invention is susceptible to numerous applications, modifications, or variations without thereby departing from the scope of protection, as defined by claims 1 and 10.

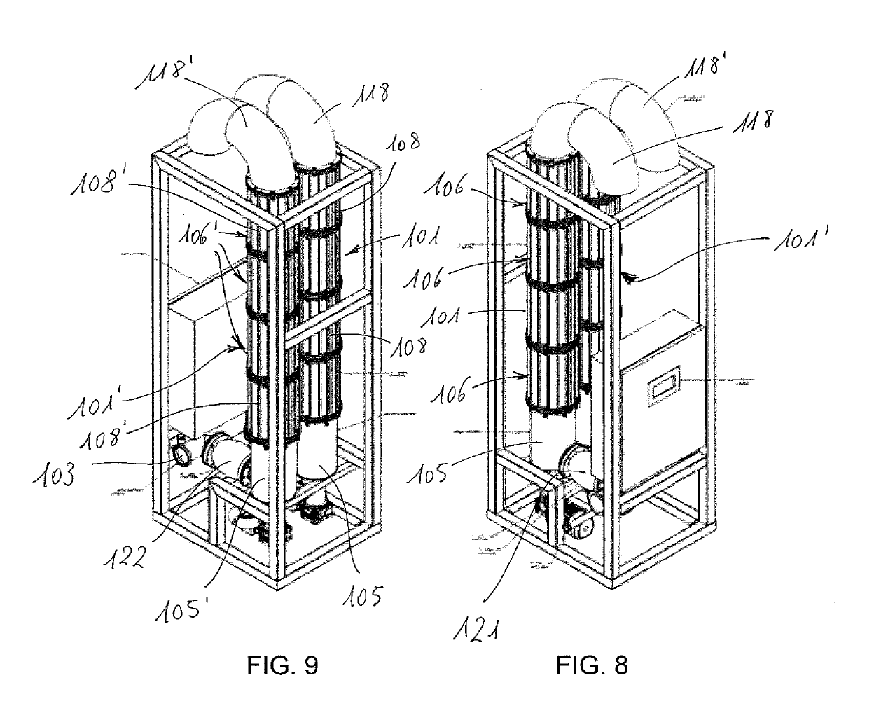

For example, as illustrated schematically in FIGS. 8 and 9, it is possible to install a pair of columns 101, 101′ alternately fed from the inlet conduit 103 via the alternate opening of the respective shut-off valves 121, 122 placed between the deviation from the inlet conduit 103 and the respective feed elements 105, 105′, so as to make the pressing process continuous, as explained below.

Although not shown in FIGS. 8 and 9, the internal structure of the two columns 101, 101′ is identical to that described for the column 1, and therefore several stages of pressing are provided, respectively, identified in the interest of brevity, by references 106, 106′, inside of which are found impermeable membranes for pressing the product. Along each column 101, 101′ at least one perforated collector tube will also be provided to separate and convey the liquid phase of the pressed product towards an outlet conduit.

The operation of the two columns 101, 101′ is alternating, i.e. while the column 101 loads the product to be processed in the feed element 105, and therefore the membranes are adhering to the outer shell 108 and the valve 121 is open, the other column presses the product through the compression of the membranes with valve 122 closed. In this way the overall capacity of the product processed is continuous and constant. Also, a more precise pressing is achieved due to the fact that, during compression, the product within the column is not pushed by the mass of incoming product.

Naturally the materials and equipment used for the realization of the present invention, as well as the shapes and dimensions of the individual components, may be made in the most appropriate way according to the specific requirements.

1. A press for pressing fruit and vegetable products comprising at least a column including a feeding module and a plurality of pressing stages; each stage of said plurality of pressing stages comprising an essentially cylindrical outer casing, a waterproof diaphragm deformable under pressure being internally associated to said outer casing each diaphragm defining a respective pressing chamber in each stage of said plurality of pressing stages, wherein at least a perforate manifold tube arranged along said column inside each pressing chamber and coaxially in respect to each outer casing.

2. A press as in claim 1, wherein said feeding module comprises an inlet mouth and feeding means adapted to transfer said fruit and vegetable products to be pressed from said inlet mouth towards said plurality of pressing stages.

3. A press as in claim 1, wherein said plurality of pressing stages comprises, in sequence, one or more primary stages adjacent said feeding module and one or more secondary stages adjacent said primary stages.

4. A press as in claim 3, wherein said primary stages are provided with a first perforated manifold tube containing a second non-perforated manifold tube coaxially arranged in respect to said first perforated manifold tube.

5. A press as in claim 3, wherein said secondary stages comprise a third perforated manifold tube coaxially arranged in respect to each outer casing of said secondary stages.

6. A press as in claim 5, wherein a junction adapted to connect said third perforated manifold tube to said second non-perforated manifold tube is provided at the coupling area between said primary stages and said secondary stages

7. A press as in claim 4, wherein said first perforated manifold tube communicates with a first outlet conduit where a first portion of liquid phase obtained by pressing said fruit and vegetable products in said one or more primary stages flows.

8. A press as in claim 4, wherein said second non-perforated manifold tube communicates with a second outlet conduit where a second portion of liquid phase obtained by pressing said fruit and vegetable products in said one or more secondary stages flows.

9. A press as in claim 3, wherein said waterproof diaphragms are adapted to be deformed by applying a pressure having a progressively increasing value from said primary stages towards said secondary stage.

10. A method for pressing fruit and vegetable products, comprising the steps of:
a. feeding the products to be pressed into a feeding module;
b. transferring the products from said feeding module towards one or more pressing chambers, wherein that it further comprises the steps of;
c. pressing said products by means of an essentially radial pressure directed from the periphery towards the center of said one or more pressing chambers;
d. separating the liquid portion obtained by pressing said products and conveying said liquid portion towards an outlet conduit by means of at least a perforated manifold tube arranged inside said one or more pressing chambers.
